(19) United States
(12) Patent Application Publication
(10) Pub. No.: US 2025/0198968 A1
(43) Pub. Date: Jun. 19, 2025

(54) CONTAINER INSPECTION METHOD, RECORDING MEDIUM, AND CONTAINER INSPECTION DEVICE

(71) Applicant: HONDA MOTOR CO., LTD., TOKYO (JP)

(72) Inventors: Takanori SUZUKI, WAKO-SHI (JP); Ichiro HARADA, WAKO-SHI (JP); Toshihiko KANEZAKI, WAKO-SHI (JP); Takashi KUWAYAMA, WAKO-SHI (JP); Masamichi KAWABE, WAKO-SHI (JP)

(21) Appl. No.: 18/978,687

(22) Filed: Dec. 12, 2024

(30) Foreign Application Priority Data
Dec. 18, 2023 (JP) 2023-212910

(51) Int. Cl. G01N 29/14

(52) U.S. Cl. CPC G01N 29/14; G01N 2291/0231

(57) ABSTRACT

A container inspection method for inspecting a container includes a detection step of sequentially detecting an AE wave generated in a container by an AE sensor while increasing the pressure inside the container, a calculation step of sequentially calculating dimensionless AE average energy by dividing AE average energy by predetermined AE specific average energy, and a determination step of determining whether an AE wave having dimensionless AE average energy exceeding a predetermined threshold indicating a sign of breakage of the container is observed until the pressure inside the container reaches a predetermined inspection pressure upper limit.

### CROSS-REFERENCE TO RELATED APPLICATIONS

This application is based upon and claims the benefit of priority from Japanese Patent Application No. 2023-212910 filed on Dec. 18, 2023, the contents of which are incorporated herein by reference.

### BACKGROUND OF THE INVENTION

### Field of the Invention

The present disclosure relates to a container inspection method, a program, and a container inspection device.

### Description of the Related Art

In recent years, research and development has been conducted on fuel cell systems that contribute to energy efficiency in order to ensure that more people can access to affordable, reliable, sustainable, and modern energy. A fuel cell system includes a container to be filled with a fuel gas (for example, hydrogen gas).

This type of container has a hollow liner to be filled with fluid and a fiber layer formed by winding a fiber member around the outer peripheral surface of the liner. WO 2014/057987 A1 discloses an inspection method for such a container. This inspection method inspects the liners for signs of fatigue failure based on AE (acoustic emission) waves generated in a container when pressure inside the container is increased. Hereinafter, acoustic emission is referred to as AE.

### SUMMARY OF THE INVENTION

There is a need for better container inspection methods, programs, and container inspection devices.

The present invention has the object of solving the aforementioned problems.

A first aspect of the present disclosure is a container inspection method for inspecting a container formed by winding a fiber member around an outer peripheral surface of a hollow liner, the container inspection method including a detection step of sequentially detecting an AE wave generated in the container by an AE sensor while increasing pressure inside the container, a calculation step of sequentially calculating dimensionless AE average energy by dividing AE average energy, which is average energy of a plurality of partial AE waves included in the AE wave detected by the AE sensor, by a predetermined AE specific average energy, which is AE average energy specific to the container, and a determination step of determining whether the AE wave having the dimensionless AE average energy exceeding a predetermined threshold indicating a sign of breakage of the container is observed until pressure inside the container reaches a predetermined inspection pressure upper limit value.

A second aspect of the present disclosure is a program causing a computer to execute the container inspection method described above.

A third aspect of the present disclosure is a container inspection device formed by winding a fiber member around an outer peripheral surface of a hollow liner, the container inspection device including: an acquisition unit that sequentially acquires an AE wave generated in the container while increasing pressure inside the container; a calculation unit that sequentially calculates dimensionless AE average energy by dividing AE average energy, which is average energy of a plurality of partial AE waves included in the AE wave acquired by the acquisition unit, by a predetermined AE specific average energy, which is AE average energy specific to the container; and a determination unit that determines whether the AE wave having the dimensionless AE average energy exceeding a predetermined threshold value indicating a sign of fatigue breakage is observed until pressure inside the container reaches a predetermined inspection pressure upper limit value.

According to the present invention, a better container inspection method, program, and container inspection device can be obtained.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a container inspection device according to an embodiment of the present invention.

FIG. 2 is a flow chart for explaining an example of a container inspection method.

FIG. 3 is an explanatory diagram of an AE wave that can be detected by an AE sensor.

FIG. 4 is a flow chart illustrating a test for setting an AE specific average energy and threshold.

FIG. 5A is a graph showing the relationship between the number of partial AE waves and pressure inside a test container. FIG. 5B is a graph showing the relationship between AE energy and pressure inside the test container.

FIG. 6A is a graph showing the relationship between cumulative AE energy and a cumulative sum of partial AE waves.

FIG. 6B is a graph showing the relationship between dimensionless AE average energy and pressure inside a test container.

FIG. 7 is a flow chart illustrating how to set the AE specific average energy and threshold when a fill-and-discharge durability test of a test container is conducted.

### DETAILED DESCRIPTION OF THE INVENTION

When containers are manufactured by winding a fiber member around the outer peripheral surface of a liner, the shape of the container tends to show variation. Therefore, there is individual variation in the shape of the containers thus produced. Moreover, because the outer peripheral surface of a fiber layer does not uniformly contact the AE sensor, there tends to be variation in the state of attachment of the AE sensor to the outer peripheral surface of the fiber layer. Therefore, in order to accurately inspect the signs of container breakage with the AE sensor, determination conditions for the AE wave indicating the signs of container breakage need to be individually set in advance for all containers.

However, such an approach is not realistic when containers are produced on an industrial scale. The present disclosure has been made in view of the above problems, and can provide a container inspection method, a program, and a container inspection device that can standardize the determination conditions for the AE waves indicating the sign of the container breakage.

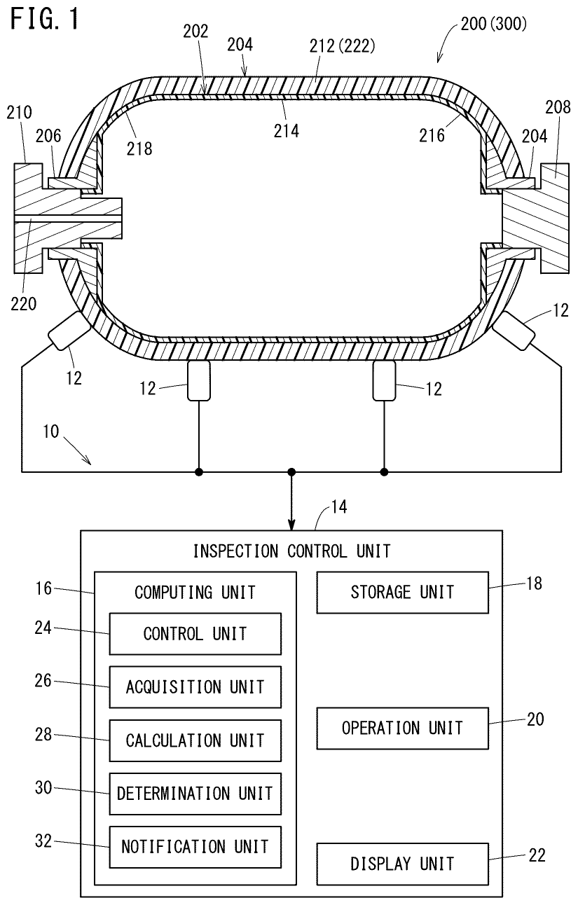

An inspection method for a container 200 and an inspection device 10 for the container 200 of the present disclosure will be described below with reference to the drawings. FIG. 1 is a schematic diagram of the inspection device 10 for the container 200. First, the container 200 to be inspected will be described. As shown in FIG. 1, the container 200 is a pressure container configured to be filled with fluid. The container 200 is, for example, a gas tank used in a fuel cell system (not shown). The gas tank can be filled with a fuel gas such as hydrogen gas. The container 200 is not limited to a gas tank.

The container 200 is a composite container. The container 200 includes a hollow liner 202, a first mouthpiece 204, a second mouthpiece 206, a sealing member 208, a plug 210, and a fiber layer 212. The liner 202 is made of resin but may be made of metal. The liner 202 is made of, for example, high-density polyethylene (HDPE) or nylon resin (PA6), which suppresses the permeation of hydrogen gas.

The liner 202 has an intermediate portion 214, a first end portion 216, and a second end portion 218. The intermediate portion 214 is formed in a cylindrical shape. The first end portion 216 is provided at one end portion of the intermediate portion 214. The second end portion 218 is provided at the other end portion of the intermediate portion 214. Each of the first end portion 216 and the second end portion 218 is formed in a hemispherical shape.

The first mouthpiece 204 is attached to the first end portion 216. The second mouthpiece 206 is attached to the second end portion 218. The sealing member 208 is attached to the first mouthpiece 204 to seal a hole of the first mouthpiece 204. The plug 210 is attached to the second mouthpiece 206. The plug 210 is formed with a flow path 220 that allow filling of fluid into the liner 202 and discharge of fluid out of the liner 202. The fiber layer 212 is formed by wrapping a fiber member 222 around the outer peripheral surface of the liner 202. The fiber member 222 is wound against the liner 202 by a filament winding device (not shown).

Next, the inspection device 10 for the container 200 will be described. The inspection device 10 inspects the presence of a sign of breakage (fatigue breakage) of the container 200. Specifically, the inspection device 10 inspects the presence of a sign of breakage of the fiber layer 212. The inspection device 10 can also inspect the presence of a sign of breakage of the liner 202.

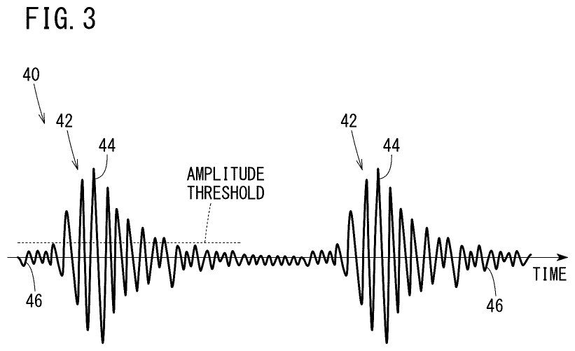

The inspection device 10 includes a plurality of AE sensors 12 and an inspection control unit 14. The AE sensors 12 are attached to the outer peripheral surface of the fiber layer 212. The positions and the number of the AE sensors 12 attached with respect to the container 200 are appropriately set according to the shape, the size, and the like of the container 200. The AE sensors 12 detect an AE wave 40 (see FIG. 3) generated in the container 200. In other words, the AE sensors 12 can sequentially measure AE waves 40 generated in the container 200.

The inspection control unit 14 includes a computing unit 16, a storage unit 18, an operation unit 20, and a display unit 22. The computing unit 16 is composed of a processor such as a CPU (Central Processing Unit), a GPU (Graphics Processing Unit), and the like. That is, the computing unit 16 is composed of processing circuitry.

The computing unit 16 includes a control unit 24, an acquisition unit 26, a calculation unit 28, a determination unit 30, and a notification unit 32. The control unit 24, the acquisition unit 26, the calculation unit 28, the determination unit 30, and the notification unit 32 can be realized by the computing unit 16 executing a program stored in the storage unit 18.

At least part of the control unit 24, the acquisition unit 26, the calculation unit 28, the determination unit 30, and the notification unit 32 may be realized by an integrated circuit such as an ASIC (Application Specific Integrated Circuit), an FPGA (Field Programmable Gate Array), and the like. In addition, at least part of the control unit 24, the acquisition unit 26, the calculation unit 28, the determination unit 30, and the notification unit 32 may be configured by an electronic circuit including a discrete device.

The storage unit 18 is composed of a volatile memory (not shown) and a nonvolatile memory (not shown). Examples of the volatile memory include a RAM (Random Access Memory). The volatile memory is used as working memory for the processor, and temporarily stores data and the like necessary for performing processes or calculations. Examples of the nonvolatile memory include ROM (Read Only Memory), flash memory, and the like. The non-volatile memory is used as memory for storage and stores programs, tables, maps, etc. At least part of the storage unit 18 may be provided in the above-described processor, integrated circuit, etc.

The operation unit 20 is used when a user operates the inspection control unit 14. The operation unit 20 includes, but is not limited to, a keyboard, a mouse, and the like.

The display unit 22 is provided with a display element (not shown). As the display element, for example, a liquid crystal display element, an organic electroluminescence display element, or the like is used. The operation unit 20 and the display unit 22 may be configured by a touch panel (not shown) provided with such a display element.

The control unit 24 governs the overall control of the inspection device 10. The acquisition unit 26 can grasp the AE waves 40 based on the signals supplied from the AE sensors 12. The calculation unit 28 calculates dimensionless AE average energy Z, which will be described later, from the AE waves 40 acquired by the acquisition unit 26. The determination unit 30 determines whether the dimensionless AE average energy Z calculated by the calculation unit 28 is larger than a predetermined threshold value Zₐ. The notification unit 32 notifies the determination results of the determination unit 30.

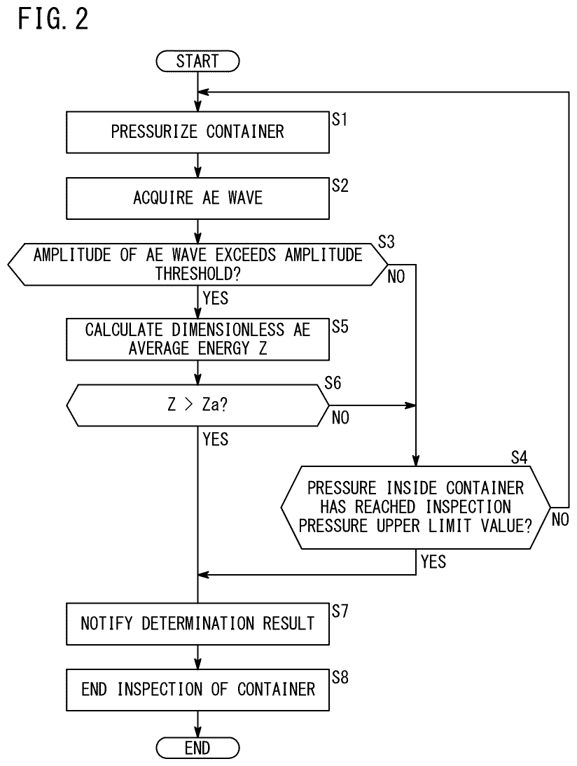

FIG. 2 is a flowchart for explaining an example of an inspection method for the container 200. As shown in FIG. 2, in step S1, the interior of the container 200 is pressurized. Specifically, the fluid is introduced into the container 200 (liner 202) via the flow path 220 of the plug 210. The fluid used here is not particularly limited, but examples include helium gas and the like. When the interior of the container 200 is pressurized, the liner 202 presses the fiber layer 212 outward. When the container 200 deforms or the container 200 cracks, the AE waves 40 are generated in the container 200. The AE wave 40 generated in the container 200 are detected by the AE sensors 12. The signals of the AE sensors 12 are supplied to the inspection control unit 14. Then, the process goes to step S2.

In step S2, the acquisition unit 26 acquires information indicating the AE waves 40 based on the signals supplied from the AE sensors 12. FIG. 3 is an explanatory diagram of the AE wave 40 that can be detected by the AE sensor 12. As shown in FIG. 3, the AE wave 40 includes a plurality of AE continuous waves 42. The AE continuous wave 42 is one continuous wave. The AE continuous wave 42 includes a plurality of partial AE waves 44 and a noise wave 46.

The partial AE wave 44 is a one period wave with an amplitude greater than a predetermined amplitude threshold. The partial AE wave 44 is a wave (acoustic wave) generated because of deformation, crack, or the like of the container 200. The noise wave 46 is a wave having an amplitude below the amplitude threshold. The amplitude threshold is stored in the storage unit 18. The amplitude threshold is set to a magnitude that can distinguish the noise wave 46 from the other waves (partial AE waves 44). Specifically, the amplitude threshold is set based on the shape and the like (including the shape, the size, the material, and the like) of the container 200, the performance of the AE sensor 12, and the like. Then, the process goes to step S3.

In step S3, the determination unit 30 determines whether the amplitude of the AE wave 40 exceeds the amplitude threshold value. That is, the determination unit 30 determines whether the AE wave 40 containing the partial AE waves 44 is generated. In other words, the determination unit 30 can determine whether the AE sensor 12 or the like is operating normally. If the determination unit 30 determines in step S3 that the amplitude of the AE wave 40 does not exceed the amplitude threshold (NO in step S3), the process goes to step S4. If the determination unit 30 determines in step S3 that the amplitude of the AE wave 40 exceeds the amplitude threshold (YES in step S3), the process goes to step S5.

In step S4, the determination unit 30 determines whether the pressure inside the container 200 has reached an inspection pressure upper limit value. The inspection control unit 14 can acquire the pressure inside the container 200 detected by a pressure sensor (not shown). The inspection pressure upper limit value is a predetermined value and stored in the storage unit 18. When the determination unit 30 determines in step S4 that the pressure inside the container 200 has not reached the inspection pressure upper limit value (NO in step S4), the process goes to step S1. When the determination unit 30 determines in step S4 that the pressure inside the container 200 has reached the inspection pressure upper limit value (YES in step S4), the process goes to step S7.

In step S5, the calculation unit 28 calculates the dimensionless AE average energy Z. First, the calculation unit 28 calculates AE average energy E_{b}. The AE average energy E_{b} is the average energy of the plurality of partial AE waves 44 contained in the AE continuous wave 42. Specifically, the calculation unit 28 calculates the AE average energy E_{b} by the following equation (1). In equation (1), Eₐ denotes the energy of the plurality of partial AE waves 44 contained in the AE continuous wave 42. Na denotes the number of partial AE waves 44 contained in the AE continuous wave 42.

$${E}_{b} = \frac{{E}_{a}}{{N}_{a}} \qquad ( 1 )$$

Subsequently, the calculation unit 28 calculates the dimensionless AE average energy Z by the following equation (2). In equation (2), Eₛₜ denotes the AE specific average energy, which is the AE average energy E_{b} specific to the container 200. The AE specific average energy Eₛₜ is determined in advance and stored in the storage unit 18. The method of setting the AE specific average energy Eₛₜ will be described later. Then, the process goes to step S6.

$$Z = \frac{{E}_{b}}{{E}_{st}} \qquad ( 2 )$$

In step S6, the determination unit 30 determines whether the dimensionless AE average energy Z calculated by the calculation unit 28 exceeds the predetermined threshold value Zₐ that indicates a sign of the breakage of the container 200. The method of setting the threshold Zₐ will be described later. When the determination unit 30 determines that the dimensionless AE average energy Z is equal to or less than the threshold value Zₐ (NO in step S6), the process goes to step S4. When the determination unit 30 determines that the dimensionless AE average energy Z exceeds the threshold value Zₐ (YES in step S6), the process goes to step S7.

In step S7, the notification unit 32 notifies the determination result. That is, if the AE wave 40 having the dimensionless AE average energy Z exceeding the threshold value Zₐ is not observed until the pressure inside the container 200 reaches the inspection pressure upper limit value (NO in step S6 and YES in step S4), the notification unit 32 notifies the determination result that the AE wave 40 indicating the sign of the breakage of the container 200 is not detected, for example. When the AE wave 40 having the dimensionless AE average energy Z exceeding the threshold Zₐ is observed until the pressure inside the container 200 reaches the inspection pressure upper limit value (YES in step S6), the notification unit 32 notifies the determination result that the AE wave 40 indicating the sign of the destruction of the container 200 has been detected, for example. The notification unit 32 notifies the user by, for example, displaying the determination result on the display unit 22, but the embodiment is not limited to this example. Then, the process goes to step S8. In step S8, the inspection of the container 200 is ended. After this, the process shown in FIG. 2 is completed.

In the inspection method for the container 200, in step S7, when a plurality of AE waves 40 having dimensionless AE average energy Z exceeding a threshold Zₐ have been observed before the pressure inside the container 200 reaches the inspection pressure upper limit value (YES in step S6), the notification unit 32 may notify the determination result that the AE wave 40 indicating the sign of the destruction of the container 200 has been detected, for example.

In the above-described inspection method, steps S1 and S2 correspond to a detection step in which the AE wave 40 generated in the container 200 is sequentially detected by the AE sensor 12 while the pressure inside the container 200 is increased. Step S5 corresponds to a calculation step of sequentially calculating the dimensionless AE average energy Z. Step S6 corresponds to a determination step.

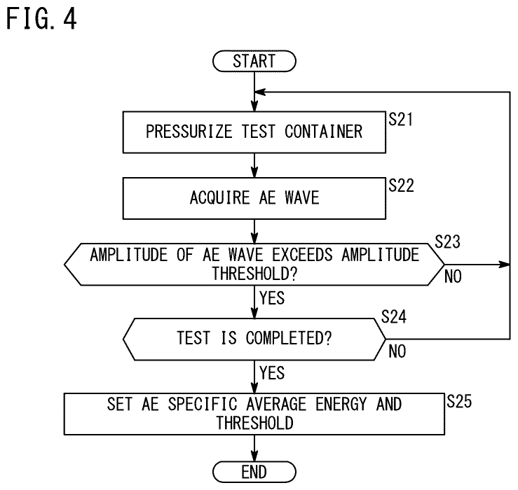

Next, a method for setting the AE specific average energy Eₛₜ and the threshold value Zₐ will be described. The AE specific average energy Eₛₜ and the threshold Zₐ may be set, for example, when a test with a test container 300 is performed. In this test, the above-described inspection device 10 is used. As shown in FIG. 1, the test container 300 is configured as the container 200 described above. FIG. 4 is a flow chart illustrating the test for setting the AE specific average energy Eₛₜ and threshold Zₐ.

As shown in FIG. 4, the processes of steps S21 to S23 are similar to the processes of steps S1 to S3 described above except that the test container 300 is used. Therefore, the specific description of the processes in steps S21 to S23 is omitted. When the determination unit 30 determines that the amplitude of the AE wave 40 exceeds the amplitude threshold (YES in step S23), the process goes to step S24.

In step S24, the determination unit 30 determines whether the test is completed. If the test is a burst test, the determination unit 30 determines that the test is completed when the test container 300 has burst, and determines that the test is not completed when the test container 300 has not yet burst. When the test is a pressure-increasing test, the determination unit 30 determines that the test is completed when the pressure inside the test container 300 has reached the predetermined test pressure upper limit value, and determines that the test is not completed when the pressure inside the test container 300 has not yet reached the test pressure upper limit value.

When the determination unit 30 determines that the test is completed (YES in step S24), the process goes to step S25. When the determination unit 30 determines that the test has not yet completed (NO in step S24), the process goes to step S21.

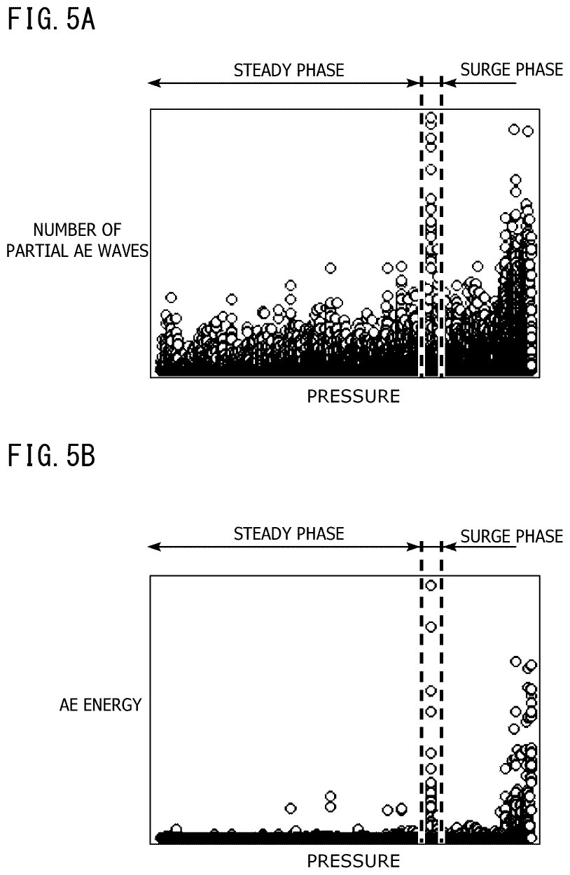

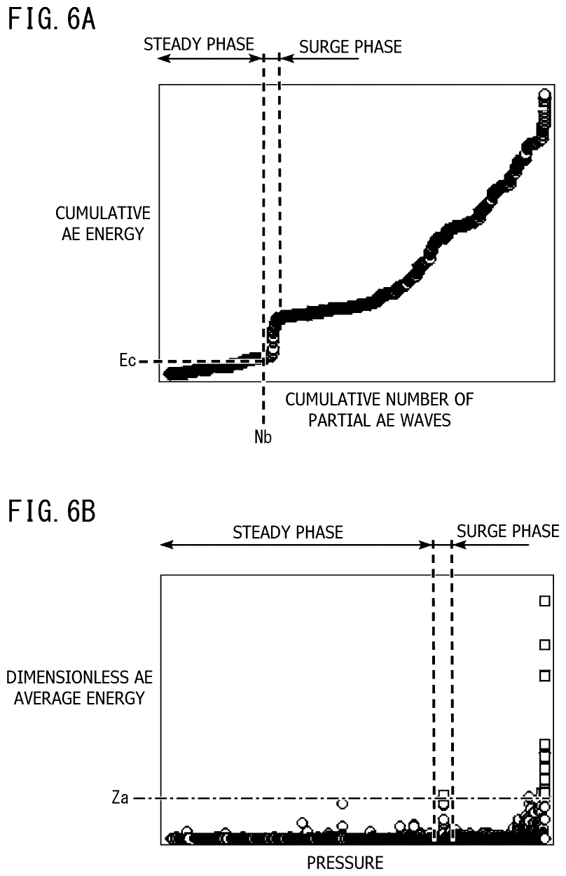

In step S25, the AE specific average energy Eₛₜ and the threshold Zₐ are set. FIGS. 5A to 6B are graphs showing test results when a burst test of the test container 300 is performed. Specifically, FIG. 5A is a graph showing the relationship between the pressure inside the test container 300 and the number of partial AE waves 44. A plot shown in FIG. 5A shows one AE continuous wave 42 (see FIG. 3). The same is true for FIG. 5B. The number of partial AE waves 44 for each plot shown in FIG. 5A can be calculated from the AE waves 40 acquired by the acquisition unit 26.

FIG. 5B is a graph showing the relationship between the pressure inside the test container 300 and the AE energy. The AE energy for each plot shown in FIG. 5B is the energy of a plurality of partial AE waves 44 contained in the AE continuous wave 42. The AE energy of each plot shown in FIG. 5B can be calculated from the AE waves 40 acquired by the acquisition unit 26.

FIG. 6A is a graph showing the relationship between cumulative AE energy and a cumulative sum of the partial AE waves 44. The cumulative sum of the partial AE waves 44 in FIG. 6A is calculated by sequentially adding up the number of partial AE waves 44 shown in FIG. 5A as the pressure inside the test container 300 increases. The cumulative AE energy of FIG. 6A is calculated by sequentially adding up the AE energy shown in FIG. 5B as the pressure inside the test container 300 increases. As shown in FIG. 6A, the slope of the graph of the cumulative AE energy is constant from the time when the partial AE waves 44 start to be detected until the cumulative sum of the partial AE waves 44 reaches N_{b}. The slope of the cumulative AE energy until the cumulative sum of the partial AE waves 44 becomes N_{b} can be calculated using equation (1) described above. The cumulative AE energy surges when the cumulative sum of the partial AE waves 44 exceeds N_{b}. In this embodiment, in FIG. 6A, a phase in which the cumulative AE energy and the cumulative sum of the partial AE waves 44 show a proportional relationship is referred to as a steady phase. A phase coming immediately after the steady phase and in which the cumulative AE energy surges is called a surge phase.

The AE specific average energy Eₛₜ is set as follows. That is, the calculation unit 28 calculates the AE specific average energy Eₛₜ by the following equation (3). In equation (3), N_{b} is the cumulative sum of partial AE waves 44 in the steady phase (just before the surge phase). E_{c} is the cumulative AE energy in the steady phase (just before the surge phase).

$${E}_{st} = \frac{{E}_{c}}{{N}_{b}} \qquad ( 3 )$$

As shown in FIG. 6A, the AE specific average energy Eₛₜ is the slope of the graph of the cumulative AE energy in the steady phase. The AE specific average energy Eₛₜ varies greatly depending on the size, shape, etc. of the container 200.

FIG. 6B is a graph showing the relationship between the pressure inside the test container 300 and the dimensionless AE average energy Z. The dimensionless AE average energy Z in FIG. 6B is calculated from the above-mentioned equation (2). As shown in FIG. 6B, in the surge phase, an AE wave 40 with a dimensionless AE average energy Z larger than the dimensionless AE average energy Z in the steady phase is detected. As a result of intensive studies, the inventors of the present application have found that the magnitude of the dimensionless AE average energy Z of the AE wave 40 that leads to the breakage (fatigue breakage) of the container 200 is not much dependent on the size, shape, etc. of the test container 300 and is substantially constant.

The threshold Zₐ may be set based on the peak (maximum) value of the dimensionless AE average energy Z during the surge period. The threshold Zₐ may be set to be smaller than the peak value of the dimensionless AE average energy Z during the surge period. The threshold value Zₐ may be set based on the results of the tests of a plurality of test containers 300. In this case, the threshold Zₐ may be set based on the average value of a plurality of test results (peak values of the dimensionless AE average energy Z during the surge period), or based on the lowest peak value among the plurality of test results (peak values of the dimensionless AE average energy Z during the surge period). After this, the process shown in FIG. 4 is completed.

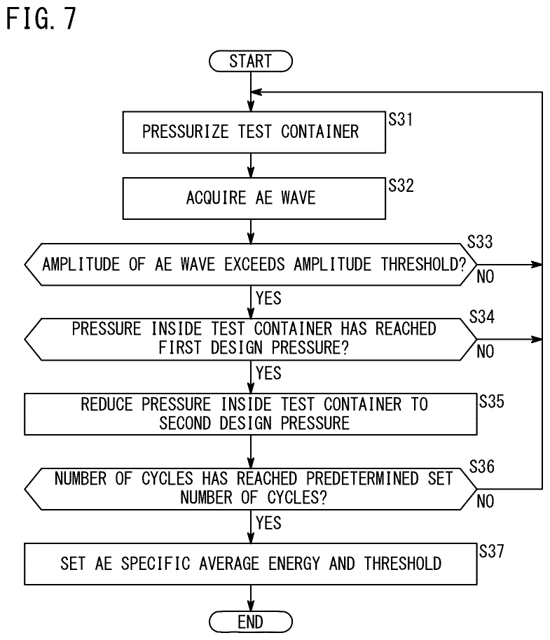

The AE specific average energy Eₛₜ and the threshold Zₐ may be set, for example, when a cycle test is performed. The cycle test is a test for confirming the durability of the test container 300 by repeating multiple times a cycle of filling the inside of the test container 300 with fluid and discharging the fluid from the test container 300. FIG. 7 is a flow chart illustrating how to set the AE specific average energy Eₛₜ and threshold Zₐ when a fill-and-discharge durability test of the test container 300 is performed.

As shown in FIG. 7, the processes of steps S31 to S33 are similar to the processes of steps S1 to S3 described above except that the test container 300 is used. Therefore, the detailed description of the processes in steps S31 to S33 is omitted. When the determination unit 30 determines that the amplitude of the AE wave 40 exceeds the amplitude threshold (YES in step S33), the process goes to step S34.

In step S34, the determination unit 30 determines whether the pressure inside the test container 300 has reached a first design pressure that is determined in advance. When the determination unit 30 determines that the pressure inside the test container 300 has not reached the first design pressure (NO in step S34), the process shifts to step S31. When the determination unit 30 determines that the pressure inside the test container 300 has reached the first design pressure (YES in step S34), the process goes to step S35.

In step S35, the control unit 24 reduces the pressure inside the test container 300 to a second design pressure. Then, the process goes to step S36.

In step S36, the determination unit 30 determines whether the number of cycles has reached a predetermined set number of cycles. When the determination unit 30 determines that the number of cycles has not reached the predetermined set number of cycles (NO in step S36), the process goes to step S31. When the determination unit 30 determines that the number of cycles has reached the predetermined set number of cycles (YES in step S36), the process goes to step S37.

The process in step S37 is similar to the process in step S25 described above. Therefore, the explanation of the specific contents of step S37 is omitted. After this, the process shown in FIG. 7 is completed.

According to this embodiment, it is determined whether an AE wave 40 having dimensionless AE average energy Z exceeding a predetermined threshold Zₐ indicative of breakage of the container 200 has been observed until the pressure inside the container 200 reaches a predetermined inspection pressure upper limit value. The dimensionless AE average energy Z of the AE wave 40 that indicates the sign of the breakage of the container 200 is not much dependent on the size, shape, etc. of the container 200. Therefore, it is not necessary to individually set the determination conditions for the AE wave 40 indicating the sign of the breakage of the container 200 for all the containers 200 in advance. That is, the determination conditions for the AE wave 40 indicating the sign of the breakage of the container 200 can be made uniform. Thus, a better inspection method for the container 200 and a better inspection device 10 for the container 200 can be provided.

The computer program (computer software) according to the present embodiment can also be referred to as a computer program product. The computer program product is not limited to the computer program recorded on a recording medium, but also includes a program transmitted, distributed, and downloaded via the Internet or the like.

With respect to the above embodiments, we further disclose the following supplementary notes.

### (Supplementary Note 1)

A container inspection method for inspecting a container (200) formed by winding a fiber member (222) around an outer peripheral surface of a hollow liner (202), including: a detection step of sequentially detecting an AE wave (40) generated in the container by an AE sensor (12) while increasing the pressure inside the container; a calculation step of sequentially calculating dimensionless AE average energy (Z) by dividing AE average energy (Ep), which is average energy of a plurality of partial AE waves (44) included in the AE wave detected by the AE sensor, by predetermined AE specific average energy (Eₛₜ), which is AE average energy specific to the container; and a determination step of determining whether the AE wave having the dimensionless AE average energy exceeding a predetermined threshold (Zₐ) indicating a sign of breakage of the container is observed until the pressure inside the container reaches a predetermined inspection pressure upper limit value.

According to such a method, it is determined whether an AE wave with dimensionless AE average energy exceeding a predetermined threshold indicative of container breakage has been observed before the pressure inside the container reaches a predetermined inspection pressure upper limit value. The dimensionless AE average energy of the AE wave, which would lead to a sign of the container breakage, is not much dependent on the container's size, shape, etc. Therefore, it is not necessary to individually set, for all the containers in advance, the determination conditions for the AE wave indicating the sign of the container breakage. That is, the determination conditions for the AE wave indicating the sign of the container breakage can be standardized. Therefore, a better inspection method can be provided.

### (Supplementary Note 2)

The container inspection method according to Supplementary note 1, wherein the partial AE wave may be a single-period wave having an amplitude larger than a predetermined amplitude threshold.

According to such a method, the influence of noise waves included in the AE wave can be eliminated, and thus the accuracy of the container inspection can be improved.

### (Supplementary Note 3)

The container inspection method according to Supplementary note 2, wherein the AE specific average energy may be average energy of the partial AE waves in a steady phase, which is previously acquired using a test container (300), and the steady phase may be a phase in which a proportional relationship is exhibited between a cumulative sum obtained by adding the number of the partial AE waves when the pressure inside the test container increases and cumulative AE energy obtained by adding the energy of the partial AE waves when the pressure inside the test container increases.

### (Supplementary Note 4)

The container inspection method according to Supplementary note 3, wherein the threshold value may be determined based on the dimensionless AE average energy given when the cumulative sum and the cumulative AE energy no longer exhibit the proportional relationship.

Such a method can improve the accuracy of the threshold indicating the sign of the breakage.

### (Supplementary Note 5)

The container inspection method according to any one of Supplementary notes 1 to 4 may further include a notification step of making a notification based on a result of the determination in the determination step.

Such a method allows a user to know the inspection results.

### (Supplementary Note 6)

In the container inspection method according to any one of Supplementary notes 1 to 5, wherein the container may have the liner made of resin.

### (Supplementary Note 7)

A program of the present disclosure is a program causing a computer to execute the container inspection method according to any one of Supplementary notes 1 to 6.

### (Supplementary Note 8)

A container inspection device (10) formed by winding a fiber member around an outer peripheral surface of a hollow liner, includes an acquisition unit (26) that sequentially acquires an AE wave generated in the container while increasing the pressure inside the container, a calculation unit (28) that sequentially calculates dimensionless AE average energy by dividing the AE average energy, which is the average energy of a plurality of partial AE waves included in the AE wave acquired by the acquisition unit, by a predetermined AE specific average energy, which is the AE average energy specific to the container, and a determination unit (30) that determines whether the AE wave having the dimensionless AE average energy exceeding a predetermined threshold value indicating a sign of fatigue breakage is observed until the pressure inside the container reaches a predetermined inspection pressure upper limit value.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiments, the order of the operations and the order of the processes are shown as an example, and are not limited to these examples. The same applies to the case where numerical values or mathematical expressions are used in the description of the above-described embodiments.

1. A container inspection method for inspecting a container formed by winding a fiber member around an outer peripheral surface of a hollow liner, comprising:
sequentially detecting an acoustic emission wave generated in the container by an acoustic emission sensor while increasing pressure inside the container;
sequentially calculating dimensionless acoustic emission average energy by dividing acoustic emission average energy, which is average energy of a plurality of partial acoustic emission waves included in the acoustic emission wave detected by the acoustic emission sensor, by predetermined acoustic emission specific average energy, which is acoustic emission average energy specific to the container; and
determining whether the acoustic emission wave having the dimensionless acoustic emission average energy exceeding a predetermined threshold indicating a sign of breakage of the container is observed until the pressure inside the container reaches a predetermined inspection pressure upper limit value.

2. The container inspection method according to claim 1, wherein
the partial acoustic emission wave is a single-period wave having an amplitude larger than a predetermined amplitude threshold.

3. The container inspection method according to claim 2, wherein
the acoustic emission specific average energy is average energy of the partial acoustic emission waves in a steady phase, which is previously acquired using a test container, and
the steady phase is a phase in which a proportional relationship is exhibited between a cumulative sum obtained by adding the number of the partial acoustic emission waves when pressure inside the test container increases and cumulative acoustic emission energy obtained by adding energy of the partial acoustic emission waves when the pressure inside the test container increases.

4. The container inspection method according to claim 3, wherein
the threshold is determined based on the dimensionless acoustic emission average energy given when the cumulative sum and the cumulative acoustic emission energy no longer exhibit the proportional relationship.

5. The container inspection method according to claim 1, wherein
a notification is made based on a result of the determining.

6. The container inspection method according to claim 1, wherein
the container includes the liner made of resin.

7. A computer-readable non-transitory recording medium storing a program causing a computer to execute the container inspection method according to claim 1.

8. A container inspection device for inspecting a container formed by winding a fiber member around an outer peripheral surface of a hollow liner, comprising:
one or more processors that executes computer-executable instructions stored in a memory,
the one or more processors execute the computer-executable instructions to cause the container inspection device to:
sequentially acquire an acoustic emission wave generated in the container while increasing pressure inside the container;
sequentially calculate dimensionless acoustic emission average energy by dividing acoustic emission average energy, which is average energy of a plurality of partial acoustic emission waves included in the acquired acoustic emission wave, by predetermined acoustic emission specific average energy, which is acoustic emission average energy specific to the container; and
determine whether the acoustic emission wave with the dimensionless acoustic emission average energy exceeding a predetermined threshold indicating a sign of fatigue breakage is observed until the pressure inside the container reaches a predetermined inspection pressure upper limit value.
